(19) United States
(12) Patent Application Publication
(10) Pub. No.: US 2026/0054584 A1
(43) Pub. Date: Feb. 26, 2026

(54) ELECTRIFIED VEHICLE

(71) Applicants: HYUNDAI MOTOR COMPANY, SEOUL (KR); KIA CORPORATION, SEOUL (KR); Seoul National University R&DB Foundation, Seoul (KR)

(72) Inventors: Yoo Jong Lee, Hwaseong-si (KR); Ho Tae Chun, Hwaseong-si (KR); Yong Jae Lee, Hwaseong-si (KR); Gyu Cheol Lim, Seoul (KR); Junhyuk Yang, Seoul (KR); Cheolmin Hwang, Seoul (KR); Jung-lk Ha, Seoul (KR)

(73) Assignees: HYUNDAI MOTOR COMPANY, SEOUL (KR); KIA CORPORATION, SEOUL (KR); Seoul National University R&DB Foundation, Seoul (KR)

(21) Appl. No.: 19/228,523

(22) Filed: Jun. 4, 2025

(30) Foreign Application Priority Data
Aug. 23, 2024 (KR) 10-2024-0113800

(51) Int. Cl. B60L 53/24; B60L 15/00; B60L 53/62; H02J 7/00

(52) U.S. Cl. CPC B60L 53/24; B60L 15/007; B60L 53/62; H02J 7/007182; H02J 2207/20

(57) ABSTRACT

Disclosed is an electrified vehicle including a motor, a dual inverter having a first DC terminal connected to a first battery and a second DC terminal connected to a second battery, and connected to both ends of the motor, a charging terminal to which a charging voltage of an external charger is applied while the external charger is connected, and a plurality of switches forming a charging path for the first battery and the second battery depending on switching states.

### CROSS-REFERENCE TO THE RELATED APPLICATION

This application claims priority from Korean Patent Application No. 10-2024-0113800, filed on Aug. 23, 2024 in the Korean Intellectual Property Office, the disclosure of which is incorporated herein by reference in its entirety.

### TECHNICAL FIELD

The present disclosure relates to an electrified vehicle having a plurality of batteries connected to a dual inverter.

### BACKGROUND

Recently, with the increasing interest in the environment, eco-friendly vehicles equipped with electric motors as a power source are on the rise. Eco-friendly vehicles are also called electric vehicles, and representative examples include hybrid vehicles (HEVs) and electric vehicles (EVs).

For small or light electric vehicles, cost competitiveness is considered, and cost reduction of not only high-voltage batteries but also power electronics (PE) components is also considered. Among high-voltage power electronics components, an expensive component is the high-voltage battery, and the price of power electronics components can be reduced by minimizing the capacity of the high-voltage battery. However, if the capacity of the high-voltage battery is reduced, not only does the range of the electric vehicle decrease, but also the output of the motor and inverter decreases.

Therefore, a motor drive system having multiple independent batteries as a voltage source may be useful.

The matters described as background technology above are only intended to enhance understanding of the background of the present disclosure and should not be taken as an acknowledgment that they correspond to prior art already known to those skilled in the art.

### SUMMARY

Therefore, the present disclosure has been made in view of the above problems, and an object of the present disclosure is to provide an electrified vehicle capable of forming a charging path for charging (e.g., all of) a plurality of batteries connected to a dual inverter (e.g., even) when charging conditions of the plurality of batteries are different.

The object of the present disclosure is not limited to the object mentioned above, and other tasks not mentioned may be understood by those skilled in the art from the description below.

In accordance with an aspect of the present disclosure, the above and other objects may be accomplished by the provision of an electrified vehicle including a motor having a plurality of windings corresponding to a plurality of phases, a dual inverter having a first DC link connected to a first battery and a second DC link connected to a second battery, and connected to both ends of (e.g., each of) the plurality of windings, a charging terminal having a first electrode connected to a first electrode of the first DC link and a first electrode of the second DC link, and a second electrode connected to a second electrode of the first DC link and a second electrode of the second DC link, a charging voltage of an external charger being applied to the charging terminal while the external charger is connected to the charging terminal, and a plurality of switches provided between the first DC link and the charging terminal and between the second DC link and the charging terminal to form a charging path for the first battery and the second battery depending on switching states.

For example, the electrified vehicle may further include a controller configured to control the switching states of the plurality of switches based on voltages of the first battery and the second battery and a maximum charging voltage applicable to the charging terminal.

For example, the controller may control the plurality of switches such that a charging path is formed, through which one of the first battery and the second battery is directly charged with the charging voltage, and the other one of the first battery and the second battery is charged using a voltage of one of the first battery and the second battery which is directly charged, when at least one of the voltage of the first battery or the voltage of the second battery is equal to or lower than the maximum charging voltage.

For example, the controller may control the plurality of switches such that the voltage of one of the first battery and the second battery, which is directly charged with the charging voltage, is converted to match the voltage of the other of the first battery and the second battery and provided to the other of the first battery and the second battery through the plurality of windings.

For example, the controller may control switching states of a plurality of legs included in the dual inverter and respectively connected to the plurality of windings such that the voltage of one of the first battery and the second battery, which is directly charged through the plurality of windings, is converted, and control the switching states of the plurality of legs such that phase currents applied to the plurality of windings have the same magnitude during the conversion.

For example, the controller may control the plurality of switches such that any one of the first battery and the second battery, whose voltage is equal to or lower than the maximum charging voltage, is directly charged with the charging voltage.

For example, the controller may control the plurality of switches such that any one of the first battery and the second battery, whose voltage exceeds the maximum charging voltage, is charged using the voltage of the one of the first battery and the second battery which is directly charged with the charging voltage.

For example, the controller may control the plurality of switches by further considering a state of charge (SoC) of each of the first battery and the second battery when both the voltage of the first battery and the voltage of the second battery are equal to or lower than the maximum charging voltage.

For example, the controller may control the plurality of switches such that any one of the first battery and the second battery, which has a relatively low SoC, is directly charged with the charging voltage.

For example, the controller may control the plurality of switches such that the charging voltage is converted to match the voltage of each of the first battery and the second battery through the plurality of windings and provided to each of the first battery and the second battery when both the voltage of the first battery and the voltage of the second battery exceed the maximum charging voltage.

For example, the controller may control the switching states of the plurality of legs included in the dual inverter and connected to the plurality of windings such that the charging voltage is converted through the plurality of windings, and control the switching states of the plurality of legs such that the phase currents applied to the plurality of windings have the same magnitude during the conversion.

For example, the plurality of switches may include a first switch electrically connecting the first electrode of the charging terminal and the first electrode of the second DC link in a turn-on state, a second switch electrically connecting the first electrode of the charging terminal and the first electrode of the first DC link in a turn-on state, a third switch electrically connecting the second electrode of the charging terminal and the second electrode of the second DC link in a turn-on state, and a fourth switch electrically connecting the second electrode of the charging terminal and the second electrode of the first DC link in a turn-on state.

For example, the electrified vehicle may further include a controller configured to control switching states of the plurality of switches based on the voltages of the first battery and the second battery and the maximum charging voltage applicable to the charging terminal.

For example, the controller may control one of the first switch and the second switch, the third switch, and the fourth switch to be turned on when at least one of the voltage of the first battery or the voltage of the second battery is equal to or lower than the maximum charging voltage.

For example, the controller may control the first switch, the third switch, and the fourth switch to be turned on when the voltage of the first battery exceeds the maximum charging voltage and the voltage of the second battery is equal to or lower than the maximum charging voltage.

For example, the controller may control the second switch, the third switch, and the fourth switch to be turned on when the voltage of the first battery is equal to or lower than the maximum charging voltage and the voltage of the second battery exceeds the maximum charging voltage.

For example, the controller may control the plurality of switches by further considering the SoC of each of the first battery and the second battery when both the voltage of the first battery and the voltage of the second battery are equal to or lower than the maximum charging voltage.

For example, the controller may control the first switch, the third switch, and the fourth switch to be turned on when both the voltage of the first battery and the voltage of the second battery are equal to or lower than the maximum charging voltage, and the SoC of the second battery is less than the SoC of the first battery.

For example, the controller may control the second switch, the third switch, and the fourth switch to be turned on when both the voltage of the first battery and the voltage of the second battery are equal to or lower than the maximum charging voltage, and the SoC of the first battery is less than the SoC of the second battery.

For example, the controller may control the second switch and the third switch to be turned on when both the voltage of the first battery and the voltage of the second battery exceed the maximum charging voltage.

### BRIEF DESCRIPTION OF THE DRAWINGS

The above and other objects, features and other advantages of the present disclosure will be understood from the following detailed description taken in conjunction with the accompanying drawings, in which:

FIG. 1 is a diagram showing a configuration of an electrified vehicle according to an embodiment of the present disclosure; and

FIGS. 2, 3, 4, 5, 6, 7, and 8 are diagrams showing charging paths for an electrified vehicle according to embodiments of the present disclosure.

### DETAILED DESCRIPTION

Specific structural and functional descriptions of the embodiments of the present disclosure, disclosed in the present application, are illustrative for the purpose of explaining the embodiments according to the present disclosure, and the embodiments according to the present disclosure may be implemented in various forms and should not be construed as being limited to the embodiments described in this application.

Since the embodiments according to the present disclosure can be modified in various manners and have various forms, specific embodiments will be illustrated in the drawings and described in detail in the application. However, this is not intended to limit the embodiments according to the concept of the present disclosure to a specific disclosed form, and should be understood to include (e.g., all) changes, equivalents, and substitutes included in the spirit and technical scope of the present disclosure.

Terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the attached drawings. However, same or similar components will be assigned the same reference numeral, and redundant descriptions thereof will be omitted.

In the description of the following embodiments, the term “preset” discloses that the value of a parameter is predetermined when the parameter is used in a process or an algorithm. Depending on embodiments, the value of a parameter may be set when a process or an algorithm starts or may be set during a period in which the process or the algorithm is performed.

The terms “module” and “unit or part” used to signify components are used herein to help the understanding of the components and thus should not be considered as having specific meanings or roles.

In the following description of the embodiments disclosed in the present application, a detailed description of known functions and configurations incorporated herein will be omitted when it may obscure the subject matter of the present disclosure. In addition, the accompanying drawings are provided only for ease of understanding of the embodiments disclosed in the present specification, do not limit the technical spirit disclosed herein, and include changes, equivalents and substitutes included in the spirit and scope of the present disclosure.

The terms “first” and/or “second” are used to describe various components, but such components are not limited by these terms. The terms are used to distinguish one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

In addition, a unit or a control unit included in names such as a motor control unit (MCU) and a hybrid control unit (HCU) may be used in naming a control device that controls specific vehicle functions and may not mean a generic functional unit.

A controller may include a communication device that communicates with other controllers or sensors to control the functions of the controller, a memory that stores an operating system, logic instructions, input/output information, or the like, and one or more processors that perform determination, computation, and decisions (e.g., necessary) to control the functions.

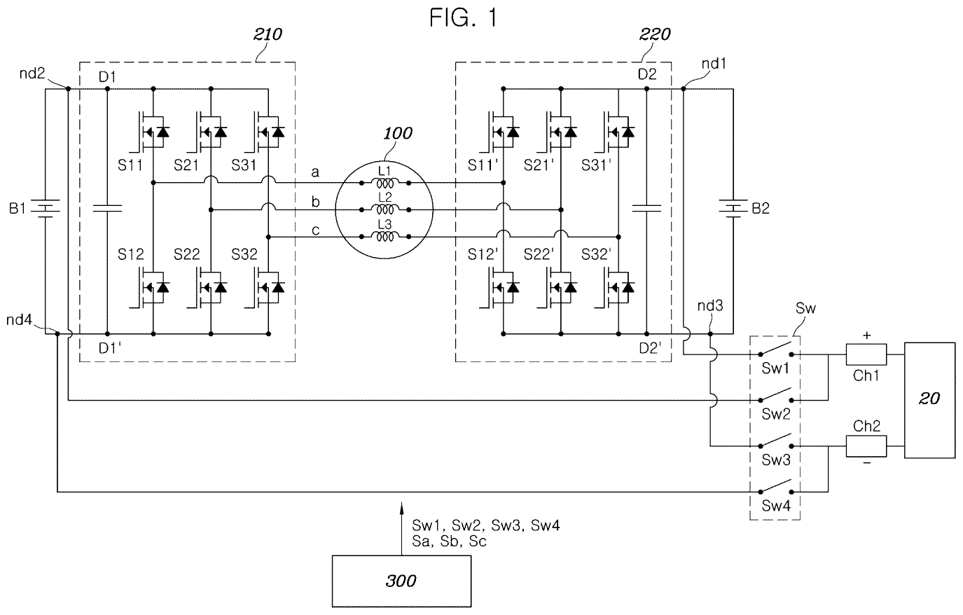

Referring to FIG. 1, an electrified vehicle according to an embodiment of the present disclosure includes a motor 100, a dual inverter (e.g., a first inverter 210 and a second inverter 220), a first battery B1, a second battery B2, a charging terminal Ch1 and Ch2, a plurality of switches Sw, and a controller 300.

Referring to FIG. 1, the motor 100 has a plurality of windings L1, L2, and L3 corresponding to a first phase a, a second phase b, and a third phase c.

The dual inverter includes the first inverter 210 and the second inverter 220 which are connected to both ends of (e.g., each of) the plurality of windings L1, L2, and L3. Specifically, the first inverter 210 has a first DC link D1 and D1′ and a plurality of legs S11-S12, S21-S22, and S31-S32 connected to one end of (e.g., each of) the plurality of windings L1, L2, and L3, and the second inverter 220 has a second DC link D2 and D2′ and a plurality of legs S11′-S12′, S21′-S22′, and S31′-S32′ connected to the other end of (e.g., each of) the plurality of windings L1, L2, and L3. The legs are connected to top switching elements S11, S21, S31, S11′, S21′, and S31′ and bottom switching elements S12, S22, S32, S12', S22', and S32′, and each element may be implemented as a transistor such as a metal-oxide-semiconductor field effect transistor (MOSFET) or an insulated gate bipolar transistor (IGBT).

The charging terminal Ch1 and Ch2 may have a first electrode Ch1 connected to a first electrode D1 of the first DC link, and a second electrode Ch2 connected to a second electrode D2′ of the second DC link. An external charger 20 may be connected to the charging terminal Ch1 and Ch2 to apply a charging voltage, and (e.g., in this case,) relays RLY1 and RLY2 may be provided between the charging terminal Ch1 and Ch2 and the first DC link D1 and the second DC link D2'.

The first battery B1 is connected to the first DC link D1 and D1′, the second battery B2 is connected to the second DC link D2 and D2′, and the first battery B1 and the second battery B2 may be charged by the charging voltage applied to the charging terminal Ch1 and Ch2. In this case, the first battery B1 and the second battery B2 may be charged independently, for example, only the first battery B1 may be charged, or only the second battery B2 may be charged. In addition, the first battery B1 and the second battery B2 may have different types and specifications, and thus may have different voltages.

In an embodiment of the present disclosure, the first battery B1 and the second battery B2 may be charged together, and in particular, even when the charging conditions of the first battery B1 and the second battery B2 are different, both the first battery B1 and the second battery B2 may be charged.

The electrified vehicle (e.g., to this end) according to an embodiment may include a plurality of switches Sw that are provided between the first DC link D1 and D1′ and the charging terminal Ch1 and Ch2 and between the second DC link D2 and D2′ and the charging terminal Ch1 and Ch2 and form a charging path for the first battery B1 and the second battery B2 according to switching state. Here, the charging path for the first battery B1 and the second battery B2 is a path for charging both the first battery B1 and the second battery B2 with a single power source and may be formed differently depending on the charging conditions of the first battery B1 and the second battery B2.

The plurality of switches Sw may include a first switch Sw1 electrically connecting the first electrode Ch1 of the charging terminal and a first electrode D2 of the second DC link in a turn-on state, a second switch Sw electrically connecting the first electrode Ch1 of the charging terminal and the first electrode D1 of the first DC link in a turn-on state, a third switch Sw electrically connecting the second electrode Ch2 of the charging terminal and the second electrode D2′ of the second DC link in a turn-on state, and a fourth switch Sw4 electrically connecting the second electrode Ch2 of the charging terminal and the second electrode D1′ of the first DC link in a turn-on state.

In this case, one end of the first switch Sw1 may be connected to the first electrode Ch1 of the charging terminal and the other end thereof may be connected to a first node nd1 formed between the first electrode Ch1 of the charging terminal and the first electrode D2 of the second DC link. One end of the second switch Sw2 may be connected to the first electrode Ch1 of the charging terminal and the other end thereof may be connected to a second node nd2 formed between the first electrode Ch1 of the charging terminal and the first electrode D1 of the first DC link. One end of the third switch Sw3 may be connected to the second electrode Ch2 of the charging terminal and the other end thereof may be connected to a third node nd3 formed between the second electrode Ch2 of the charging terminal and the second electrode D2′ of the second DC link. One end of the fourth switch Sw4 may be connected to the second electrode Ch2 of the charging terminal and the other end thereof may be connected to a fourth node nd4 formed between the second electrode Ch2 of the charging terminal and the second electrode D1′ of the first DC link.

In order to form the charging path as described above, the controller 300 may control the switching states of the plurality of switches Sw based on the voltages of the first battery B1 and the second battery B2 and a maximum charging voltage applicable to the charging terminals Ch1 and Ch2.

In an embodiment, the controller 300 may be implemented as a motor control unit (MCU) and may be connected to a battery management system (BMS) equipped in the vehicle to obtain the voltages and charging current commands of the first battery B1 and the second battery B2. Alternatively, the controller 300 may be implemented as a high-level controller such as a vehicle control unit (VCU) or a hybrid control unit (HCU) having the functions of the motor control unit (MCU) and the battery management system (BMS). In addition, the maximum charging voltage is a maximum value of a charging voltage applicable to the charging terminal Ch1 and Ch2, and the value thereof may be determined according to the specifications of the external charger connected to the charging terminal. The controller 300 may obtain the maximum charging voltage, for example, through communication with the external charger.

Switching state control of the first inverter 210 and the second inverter 220 may be performed by controlling on/off of the top switching elements and the bottom switching elements of the legs S11-S12, S21-S22, S31-S32, S11′-S12′, S21′-S22′, and S31′-S32′ included in the first inverter 210 and the second inverter 220 through switching signals Sa, Sb, and Sc for the respective phases. In this case, the controller 300 can control the currents flowing through the phases a, b, and c such that they have the same value, thereby preventing rotation of the connected motor 100 while the first battery B1 and the second battery B2 are being charged through the first inverter 210 and the second inverter 220.

According to the (e.g., aforementioned) electrified vehicle having the plurality of switches Sw and the controller 300, (e.g., even) when the charging conditions of the first battery B1 and the second battery B2 serve as a dual voltage source in a dual inverter structure having a dual voltage source are different, both the first battery B1 and the second battery B2 may be charged with a single power source, and accordingly, it is proposed to perform battery charging with (e.g., optimal) efficiency in various charging scenarios according to the charging conditions of the first battery B1 and the second battery B2.

Here, the charging conditions of the first battery B1 and the second battery B2 may be determined according to voltages of the first and second batteries B1 and B2, charging current commands, and the relationship between the voltages and the maximum charging voltage.

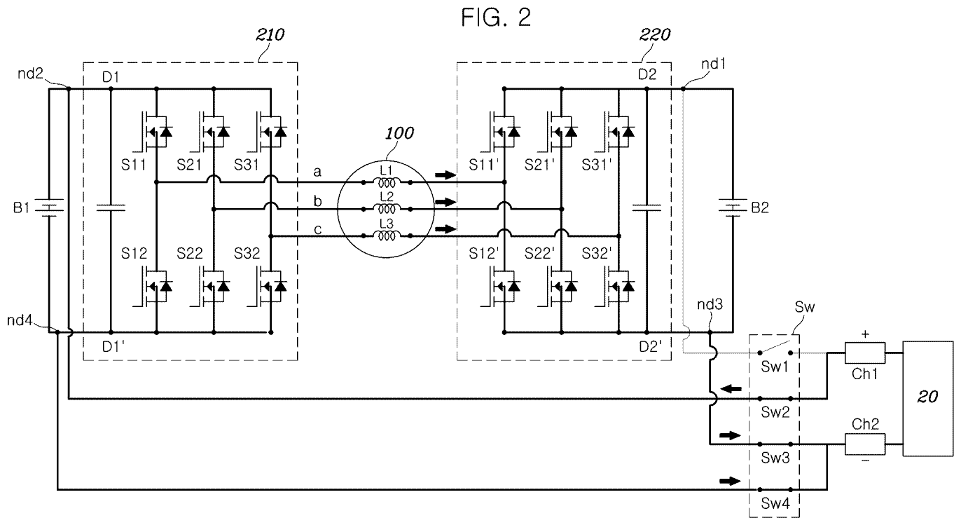

Hereinafter, specific control methods for (e.g., efficiently) charging both the first battery B1 and the second battery B2 in cases where the charging conditions of the first battery B1 and the second battery B2 are different will be described with reference to FIG. 2 to FIG. 8.

FIGS. 2, 3, 4, 5, 6, 7, and 8 are diagrams showing charging paths for an electrified vehicle according to an embodiment of the present disclosure.

First, referring to FIG. 2 to FIG. 4, the controller 300 may control the plurality of switches Sw such that a charging path is formed, through which one of the first battery B1 and the second battery B2 is directly charged with a charging voltage and the other one of the first battery B1 and the second battery B2 is charged using the voltage of one of the first battery B1 and the second battery B2 that is directly charged, when at least one of the voltage of the first battery B1 and the voltage of the second battery B2 is equal to or lower than a maximum charging voltage.

To this end, the controller 300 may control one of the first switch Sw1 and/or the second switch Sw2, the third switch Sw3, and the fourth switch Sw4 to be turned on.

That is, when at least one of the voltage of the first battery B1 or the voltage of the second battery B2 is equal to or lower than the maximum charging voltage, the first switch Sw1, the third switch Sw3, and the fourth switch Sw4 can be turned on, or the second switch Sw2, the third switch Sw3, and the fourth switch Sw4 can be turned on.

More specifically, the controller 300 may control the plurality of switches Sw such that any one of the first battery B1 and the second battery B2, whose voltage is equal to or lower than the maximum charging voltage, is directly charged with the charging voltage.

If (e.g., only) one of the voltage of the first battery B1 and the voltage of the second battery B2 is equal to or lower than the maximum charging voltage, the controller 300 may control the plurality of switches Sw such that any one of the first battery B1 and the second battery B2, whose voltage exceeds the maximum charging voltage, is charged using the voltage of the one of the first battery B1 and the second battery B2 which is directly charged with the charging voltage.

On the other hand, when both the voltage of the first battery B1 and the voltage of the second battery B2 are equal to or lower than the maximum charging voltage, the controller 300 may control the plurality of switches Sw in further consideration of the state of charge (SoC) of each of the first battery B1 and the second battery B2, and for example, may control the plurality of switches Sw such that any one of the first battery B1 and the second battery B2 that has a (e.g., relatively) low SoC is directly charged with the charging voltage.

FIG. 2 to FIG. 4 illustrate an example of a case in which a charging path through which the first battery B1 is directly charged with the charging voltage and the second battery B2 is charged using the voltage of the first battery B1 that is charged with the charging voltage is formed. In this case, the controller 300 controls the second switch Sw2, the third switch Sw3, and the fourth switch Sw4 to be turned on.

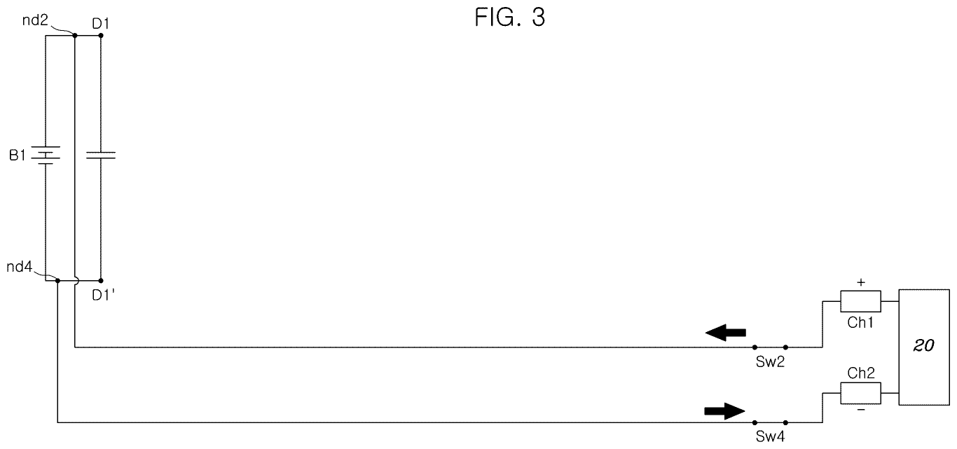

Through this charging path, the current due to the charging voltage is transmitted to the first battery B1 through the first electrode Ch1 of the charging terminal, the second switch Sw2, and the second node nd2, as shown in FIG. 3, and the current passing through the first battery B1 returns to the second electrode Ch2 of the charging terminal through the fourth node nd4 and the fourth switch Sw4. Accordingly, the first battery B1 can be directly charged with the charging voltage.

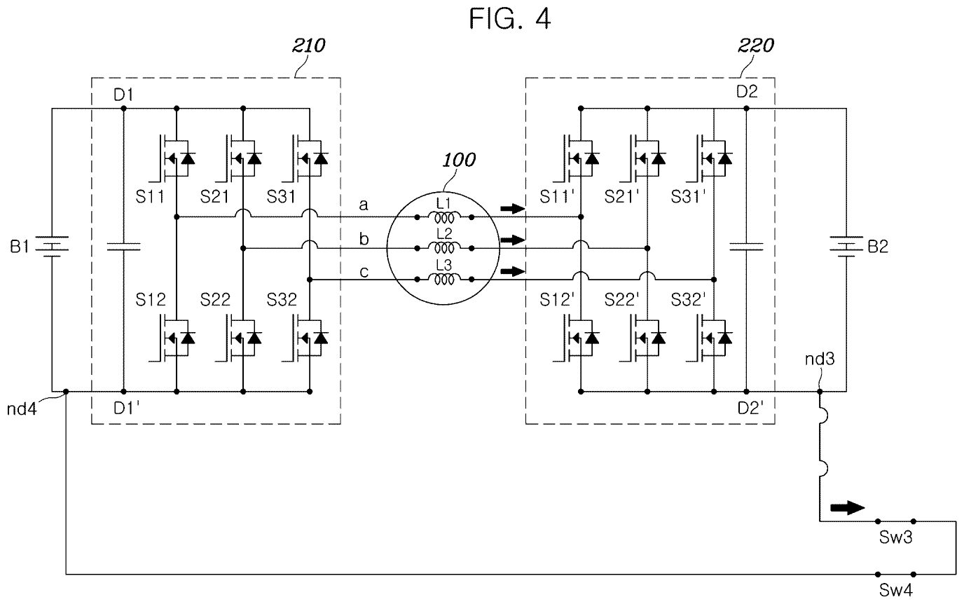

Through this charging path, the current due to the voltage of the first battery B1 is transmitted to the second battery B2 through the first electrode D1 of the first DC link, the first inverter 210, the plurality of windings L1, L2, and L3, the second inverter 220, and the first electrode D2 of the second DC link, as shown in FIG. 4, and the current passing through the second battery B2 returns to the first battery B1 through the third node nd3, the third switch Sw3, the fourth switch Sw4, and the fourth node nd4.

In addition, the controller 300 may control the plurality of switches Sw such that the voltage of one of the first battery B1 and the second battery B2, which is directly charged with the charging voltage, is converted to match the voltage of the other one of the first battery B1 and the second battery B2 through the plurality of windings L1, L2, and L3 and provided to the other one of the first battery B1 and the second battery B2. In this case, the controller 300 may convert the voltage of one of the first battery B1 and the second battery B2, which is directly charged through the plurality of windings L1, L2, L3, and control the switching states of the plurality of legs such that phase currents applied to the plurality of windings L1, L2, and L3 have the same magnitude during conversion to prevent torque from being generated in the motor 100 during charging of the first battery B1 and the second battery B2 by controlling the switching states of the plurality of legs S11-S12, S21-S22, S31-S32, S11′-S12′, S21′-S22′, and S31′-S32′ included in the dual inverter 210 and 220 and connected to the plurality of windings L1, L2, and L3.

More specifically, referring to FIG. 4, the controller 300 may turn on and turn off the top switching elements and the bottom switching elements of the plurality of legs S11-S12, S21-S22, S31-S32, S11′-S12′, S21′-S22′, and S31′-S32′ to convert the voltage of the first battery B1, which is directly charged with the charging voltage, to match the voltage of the second battery B2 through the plurality of windings L1, L2, and L3. For example, when the voltage of the first battery B1 is lower than the voltage of the second battery B2, the voltage of the first battery B1 is boosted to match the voltage of the second battery B2 according to the above control, and accordingly, the second battery B2 can be charged.

Meanwhile, a charging path through which the second battery B2 is directly charged with the charging voltage and the first battery B1 is charged using the voltage of the second battery B2 that is directly charged with the charging voltage may be formed by the controller 300 controlling the first switch Sw1, the third switch Sw3, and the fourth switch Sw4 to be turned on.

Through this charging path, the current due to the charging voltage is transmitted to the second battery B2 through the first electrode Ch1 of the charging terminal, the first switch Sw1, and the first node nd1, and the current passing through the second battery B2 returns to the second electrode Ch2 of the charging terminal through the third node nd3 and the third switch Sw3, and thus the second battery B2 can be directly charged with the charging voltage.

Through this charging path, the current due to the voltage of the second battery B2 is transmitted to the first battery B1 through the first electrode D2 of the second DC link, the second inverter 220, the plurality of windings L1, L2, and L3, the first inverter 220, and the first electrode D1 of the first DC link, and the current passing through the first battery B1 returns to the second battery B2 through the fourth node nd4, the fourth switch Sw4, the third switch Sw3, and the third node nd3.

In this case, the controller 300 may turn on and turn off the top switching elements and bottom switching elements of the plurality of legs S11-S12, S21-S22, S31-S32, S11′-S12′, S21′-S22′, and S31′-S32′ to convert the voltage of the second battery B2, which is directly charged with the charging voltage, to match the voltage of the first battery B1 through the plurality of windings L1, L2, and L3. For example, when the voltage of the second battery B2 is lower than the voltage of the first battery B1, the voltage of the second battery B2 is boosted to match the voltage of the first battery B1 through the above control, and accordingly, the first battery B1 can be charged.

FIG. 3 and FIG. 4 illustrates a (e.g., one) charging path formed when the plurality of switches Sw are controlled as shown in FIG. 2 from the viewpoints of the batteries B1 and B2, and charging of the first battery B1 illustrated in FIG. 3 and charging of the second battery B2 illustrated in FIG. 4 are performed simultaneously.

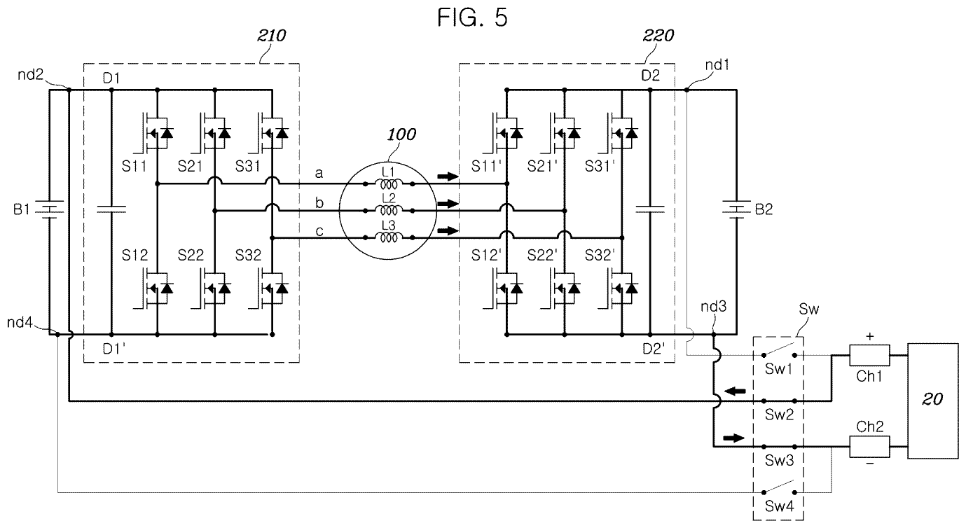

Referring to FIG. 5 to FIG. 8, the controller 300 may control the plurality of switches Sw such that a charging path is formed through which the charging voltage is converted to match the voltages of the first battery B1 and the second battery B2 through the plurality of windings L1, L2, and L3 and provided to the first battery B1 and the second battery B2. To this end, the controller 300 may control the second switch Sw2 and the third switch Sw3 to be turned on.

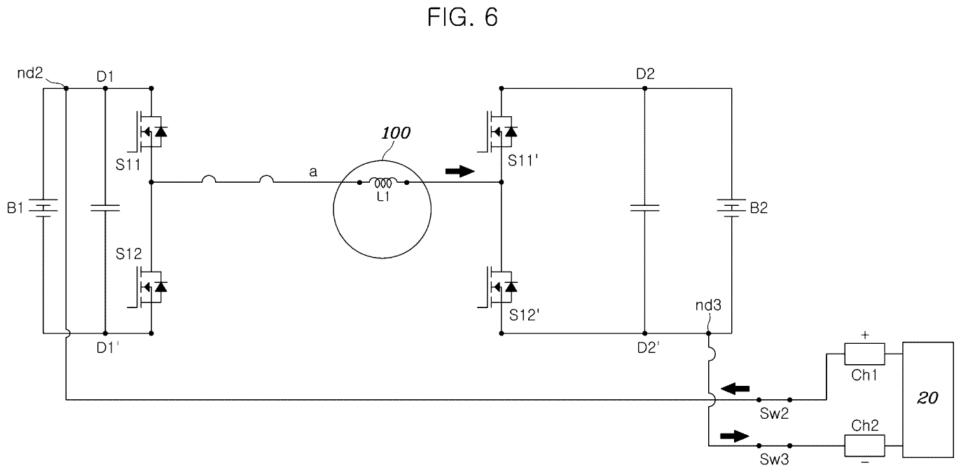

The controller 300 may convert the charging voltage through the plurality of windings L1, L2, and L3 by controlling the switching states of the plurality of legs S11-S12, S21-S22, S31-S32, S11′-S12′, S21′-S22′, and S31′-S32′ included in the dual inverter 210 and 220 and connected to the plurality of windings L1, L2, and L3. In this case, the phase currents of the phases a, b, and c can flow as shown in FIG. 6 to FIG. 8, and in this process, the first battery B1 and the second battery B2 are charged. In addition, the controller 300 may control the switching states of the plurality of legs S11-S12, S21-S22, S31-S32, S11′-S12′, S21′-S22′, and S31′-S32′ such that the phase currents of the phases a, b, and c have the same magnitude in order to prevent torque generation in the motor 100 during the process of charging the first battery B1 and the second battery B2.

FIG. 6 to FIG. 8 illustrate a (e.g., one) charging path formed when the plurality of switches Sw are controlled as shown in FIG. 5 from the viewpoints of the phases a, b, and c, and charging of the first battery B1 and the second battery B2 through the phases a, b, and c illustrated in FIG. 6 to FIG. 8 can be performed simultaneously.

Referring to FIG. 6, which illustrates a charging path according to phase a among the phases a, b, and c, such that the current caused by the charging voltage may be transmitted from the first electrode Ch1 of the charging terminal to the second node nd2 through the second switch Sw2. In this case, depending on the switching states of the first inverter 210 and the second inverter 220, both the first battery B1 and the second battery B2 can be charged.

For example, if the top switching element S11 of the first inverter 210 is turned on in a state in which the bottom switching element S12′ of the second inverter 220 is turned on, current is charged in the winding L1 corresponding to phase a through the current caused by the charging voltage, and then, if the bottom switching element S12 of the first inverter 210 is turned on, the first battery B1 can be charged using the current charged in the winding L1 corresponding to phase a. In addition, if the bottom switching element S12′ of the second inverter 220 is turned on in a state in which the top switching element S11 of the first inverter 210 is turned on, current is charged in the winding L1 corresponding to phase a, and then, if the top switching element S11′ of the second inverter 220 is turned on, the second battery B2 can be charged through the current charged in the winding L1 corresponding to phase a.

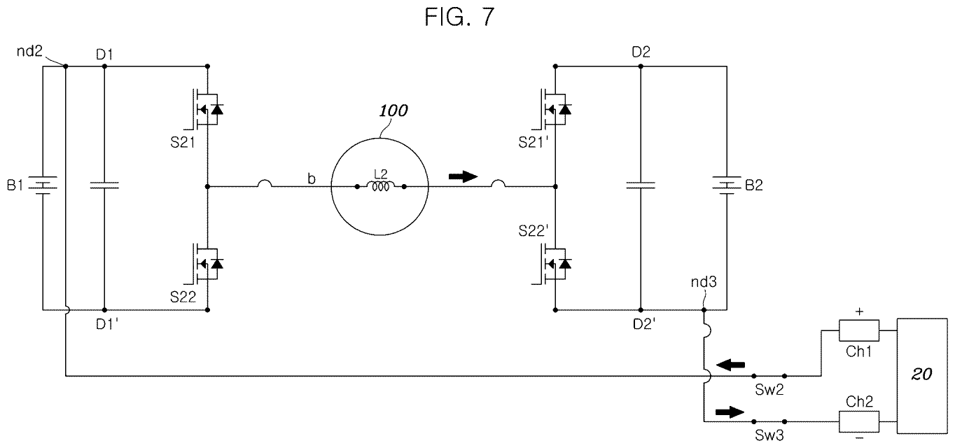

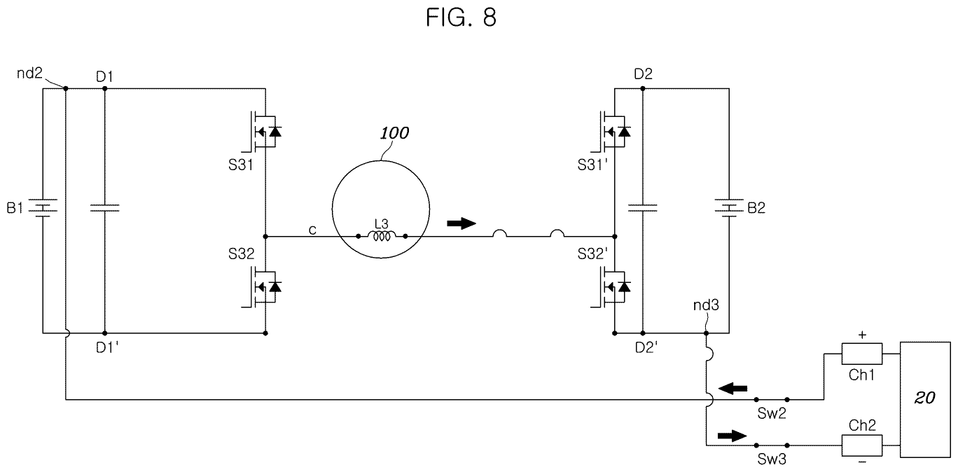

This method of charging the first battery B1 and the second battery B2 through the first inverter 210 and the second inverter 220 is also applied in the example illustrated in FIG. 7 and FIG. 8, such that charging of the first battery B1 and the second battery B2 can be performed through phase b in the case of FIG. 7, and charging of the first battery B1 and the second battery B2 can be performed through phase c in the case of FIG. 8.

According to various embodiments of the present disclosure as described above, even when the charging conditions of a plurality of batteries serving as a dual voltage source of an electrified vehicle are different, it is possible to charge (e.g., all of) the batteries with a single power source.

Furthermore, in various charging scenarios according to the charging conditions of the plurality of batteries, battery charging can be performed with (e.g., optimal) efficiency.

The effects that can be obtained from the present disclosure are not limited to the effects mentioned above, and other effects that are not mentioned can be clearly understood by those skilled in the art.

Although the present disclosure has been illustrated and described with respect to specific embodiments as described above, it will be apparent to those skilled in the art that the present disclosure can be improved and changed in various manners without departing from the technical spirit of the present disclosure provided by the claims.

What is claimed is:

1. An electrified vehicle comprising:
a motor including a plurality of windings corresponding to a plurality of phases;
a dual inverter including a first DC link connected to a first battery and a second DC link connected to a second battery, and connected to both ends of each of the plurality of windings;
a charging terminal including a first electrode connected to a first electrode of the first DC link and a first electrode of the second DC link, and a second electrode connected to a second electrode of the first DC link and a second electrode of the second DC link, a charging voltage of an external charger being applied to the charging terminal while the external charger is connected to the charging terminal; and
a plurality of switches provided between the first DC link and the charging terminal and between the second DC link and the charging terminal to form a charging path for the first battery and the second battery depending on switching states.

2. The electrified vehicle of claim 1, further comprising a controller configured to control the switching states of the plurality of switches based on voltages of the first battery and the second battery and a maximum charging voltage applicable to the charging terminal.

3. The electrified vehicle of claim 2, wherein the controller is configured to control the plurality of switches such that a charging path, through which one of the first battery and the second battery is directly charged with the charging voltage, and the other one of the first battery and the second battery is charged using a voltage of the one of the first battery and the second battery which is directly charged, is formed when at least one of the voltage of the first battery or the voltage of the second battery is equal to or lower than the maximum charging voltage.

4. The electrified vehicle of claim 3, wherein the controller is configured to control the plurality of switches such that the voltage of one of the first battery and the second battery, which is directly charged with the charging voltage, is converted to match the voltage of the other of the first battery and the second battery and provided to the other of the first battery and the second battery through the plurality of windings.

5. The electrified vehicle of claim 4, wherein the controller is configured to control switching states of a plurality of legs included in the dual inverter and respectively connected to the plurality of windings such that the voltage of one of the first battery and the second battery, which is directly charged through the plurality of windings, is converted, and to control the switching states of the plurality of legs such that phase currents applied to the plurality of windings have the same magnitude during the conversion.

6. The electrified vehicle of claim 3, wherein the controller is configured to control the plurality of switches such that any one of the first battery and the second battery, whose voltage is equal to or lower than the maximum charging voltage, is directly charged with the charging voltage.

7. The electrified vehicle of claim 6, wherein the controller is configured to control the plurality of switches such that any one of the first battery and the second battery, whose voltage exceeds the maximum charging voltage, is charged using the voltage of the one of the first battery and the second battery which is directly charged with the charging voltage.

8. The electrified vehicle of claim 3, wherein the controller is configured to control the plurality of switches by further considering a state of charge of each of the first battery and the second battery when both the voltage of the first battery and the voltage of the second battery are equal to or lower than the maximum charging voltage.

9. The electrified vehicle of claim 8, wherein the controller is configured to control the plurality of switches such that any one of the first battery and the second battery, which has a relatively low state of charge, is directly charged with the charging voltage.

10. The electrified vehicle of claim 2, wherein the controller is configured to control the plurality of switches such that the charging voltage is converted to match the voltage of each of the first battery and the second battery through the plurality of windings and provided to each of the first battery and the second battery when both the voltage of the first battery and the voltage of the second battery exceed the maximum charging voltage.

11. The electrified vehicle of claim 10, wherein the controller is configured to control the switching states of a plurality of legs included in the dual inverter and connected to the plurality of windings such that the charging voltage is converted through the plurality of windings, and to control the switching states of the plurality of legs such that phase currents applied to the plurality of windings have the same magnitude during the conversion.

12. The electrified vehicle of claim 1, wherein the plurality of switches comprises:
a first switch electrically connecting the first electrode of the charging terminal and the first electrode of the second DC link in a turn-on state;
a second switch electrically connecting the first electrode of the charging terminal and the first electrode of the first DC link in a turn-on state;
a third switch electrically connecting the second electrode of the charging terminal and the second electrode of the second DC link in a turn-on state; and
a fourth switch electrically connecting the second electrode of the charging terminal and the second electrode of the first DC link in a turn-on state.

13. The electrified vehicle of claim 12, further comprising a controller configured to control switching states of the plurality of switches based on the voltages of the first battery and the second battery and the maximum charging voltage applicable to the charging terminal.

14. The electrified vehicle of claim 13, wherein the controller is configured to control one of the first switch and the second switch, the third switch, and the fourth switch to be turned on when at least one of the voltage of the first battery or the voltage of the second battery is equal to or lower than the maximum charging voltage.

15. The electrified vehicle of claim 14, wherein the controller is configured to control the first switch, the third switch, and the fourth switch to be turned on when the voltage of the first battery exceeds the maximum charging voltage and the voltage of the second battery is equal to or lower than the maximum charging voltage.

16. The electrified vehicle of claim 14, wherein the controller is configured to control the second switch, the third switch, and the fourth switch to be turned on when the voltage of the first battery is equal to or lower than the maximum charging voltage and the voltage of the second battery exceeds the maximum charging voltage.

17. The electrified vehicle of claim 14, wherein the controller is configured to control the plurality of switches by further considering a state of charge of each of the first battery and the second battery when both the voltage of the first battery and the voltage of the second battery are equal to or lower than the maximum charging voltage.

18. The electrified vehicle of claim 17, wherein the controller is configured to control the first switch, the third switch, and the fourth switch to be turned on when both the voltage of the first battery and the voltage of the second battery are equal to or lower than the maximum charging voltage, and the state of charge of the second battery is less than the state of charge of the first battery.

19. The electrified vehicle of claim 17, wherein the controller is configured to control the second switch, the third switch, and the fourth switch to be turned on when both the voltage of the first battery and the voltage of the second battery are equal to or lower than the maximum charging voltage, and the state of charge of the first battery is less than the state of charge of the second battery.

20. The electrified vehicle of claim 13, wherein the controller is configured to control the second switch and the third switch to be turned on when both the voltage of the first battery and the voltage of the second battery exceed the maximum charging voltage.
